(19) United States
(12) Patent Application Publication
(10) Pub. No.: US 2024/0264627 A1
(43) Pub. Date: Aug. 8, 2024

(54) Satellite And Miniature Atomic Clocks For Near Perfect Time For Distributed Blockchain Non-Interactive Synchronization

(71) Applicant: Joshua Tobkin, Perham, MN (US)

(72) Inventor: Joshua Tobkin, Perham, MN (US)

(21) Appl. No.: 18/582,012

(22) Filed: Feb. 20, 2024

Related U.S. Application Data
(63) Continuation of application No. PCT/US22/40618, filed on Aug. 17, 2022.
(60) Provisional application No. 63/234,222, filed on Aug. 17, 2021.

(51) Int. Cl. G06F 1/12

(52) U.S. Cl. CPC G06F 1/12

(57) ABSTRACT

A distributed ledger system comprising a plurality of nodes wherein each node includes a Time Card hardware extension and a memory for storing block data. The “Time Card” hardware extension that contains an atomic clock and a Global Navigation Satellite System (GNSS) receiver, which is an electronic device that receives and digitally processes signals from a navigation satellite constellation in order to derive highly accurate time. The Time Card is configured to communicate with a satellite using the GNSS receiver to coordinate time with the plurality of nodes. The plurality of nodes configured to operate according to a consensus algorithm operating on a block schedule.

### REFERENCE TO RELATED PATENT APPLICATION

The present application claims benefit of U.S. Provisional Application No. 63/234,222, filed on Aug. 17, 2021.

### TECHNICAL FIELD

The subject matter described herein relates to an improved time synchronization system and method used in distributed systems, including blockchain systems, more specifically blockchain consensus protocols or mechanisms.

### BACKGROUND/SUMMARY

It is difficult to get an agreement about time in a distributed system, where there are clock value errors, clock skew, and correspondence time.

Time synchronization in distributed systems poses an issue in terms of database updates and other tasks such as scheduled cronjobs (e.g., help OS to take a scheduled backup of log files or a database) to be performed and other mandatory database maintenance requirements. Blockchains themselves are distributed systems and suffer from similar time related degradation of performance if not well synchronized. If there were a source of perfect timing synchronization, blockchain performance would be improved.

Some of these improvements include the ability to detect blockchain liveness failures with more precision. For example, when a leader block proposer node goes offline or crashes it can be replaced more quickly thereby reducing total down time of the system. For example, when a leader node crashes or needs to be replaced, the network generally has to acknowledge this occurrence, agree on it on a global round of voting, and then move forward thereafter. Since the Internet is an asynchronous environment where messaging between nodes can take various amounts of time, sometimes multiple seconds, blockchain systems generally introduce a time delta that any node should wait before it votes that the leader is crashed and needs to be replaced. See, e.g., FIG. 5C. Then enough responses need to be sent around the network to ensure that enough nodes also believe that the leader node is crashed and must be replaced. And then finally the network needs to agree on what to do next. There are multiple rounds of communication to determine if a leader is crashed or not. With the Time Card method, however, nodes can automatically move forward after a certain amount of time to the next leader more smoothly and faster.

Additionally, with a reliable notion of time between distributed nodes, block production can be improved and optimized, as scheduling block production may be agreed upon in advance, thereby increasing the rate and reliability of block production and consensus. In short, nodes would know whom to direct data to and who should be producing which blocks at which time, allowing the blockchain to more precisely prepare block data to be processed and proposed for consensus. The result enabled is a highly performant blockchain that can rapidly produce blocks, schedule tasks and smart (self-executing) contract execution, and stay in sync without having to rely on data packets sent through a partially synchronous communication environment, like the Internet, which is known to have reliability vulnerabilities.

For example, the Internet is relatively slow compared to the speed of light due to messages having to go through hubs and convoluted fiber optic cables through the world's oceans. Moreover, sometimes messages along the way are dropped or missed adding addition trips back and forth from the sender and receiver adding more latency. Every computer may have a slightly different view of their local notion of time and then to communicate with each other over a sometimes highly unreliable Internet connection can exacerbate clock drift so extremely precise synchronization becomes difficult if not impossible. With Time Cards, however, the nodes are able to communicate with Satellites at the speed of light through radio waves at much faster speeds. With all the nodes utilizing their Time Cards to coordinate on their time, they are all able to have the same notion of time to the microsecond, which is substantially smaller than a millisecond, without the drawbacks of communicating over the open Internet.

It is to be understood that both the foregoing general description and the following detailed description are exemplary and explanatory and are intended to provide further explanation of the subject matter as claimed.

### BRIEF DESCRIPTION OF DRAWINGS

The accompanying drawing constitutes a part of this specification and illustrates an embodiment that, together with the specification, explains the subject matter.

FIG. 1 shows one embodiment of the present system.

FIG. 2 shows one embodiment of a Time Card used in the present system.

FIGS. 3A and 3B are examples illustrating the difference between non-Time Card system communication pattern to reach agreement on time (FIG. 3A) and a system with Time Card utilization (FIG. 3B).

FIG. 4 illustrates various phases of a blockchain consensus algorithm utilizing a Time Card, according to one embodiment.

FIG. 5A illustrates one example of block production in a happy path where each designated leader forms and proposes their respective blocks within their allotted time windows.

FIG. 5B illustrates one example of a case when certain leaders unable to produce a block and disseminate it within its designated Time Window.

FIG. 5C illustrates one example of a time delay comparison required to create two blocks in the presence of crashed leader nodes that required a view change protocol voting scheme across the Internet.

### DETAILED DESCRIPTION

The following detailed description is provided with reference to the drawing. Exemplary embodiments are described to illustrate the disclosure, not to limit its scope, which is defined by the claims. Those of ordinary skill in the art will recognize a number of equivalent variations in the description that follows without departing from the scope and spirit of the disclosure.

Each and every node in the network utilizes a “Time Card” hardware extension that contains both an atomic clock (e.g., an extremely accurate type of clock which is regulated by the vibrations of an atomic or molecular system such as cesium or ammonia) as well as a Global Navigation Satellite System (GNSS) receiver, which is an electronic device that receives and digitally processes signals from a navigation satellite constellation in order to derive highly accurate time.

All blockchain nodes (e.g., device or point on a blockchain network, which keeps a copy of a transaction on the network and may perform essential functions such as validating and authenticating a transaction) that connect to the “Time Card” hardware, which is open sourced commodity hardware, may be able to communicate with satellite constellations to synchronize their clocks in a highly accurate manner. Plus, the internal miniature atomic clock on these hardware extensions to the operating node can help the node maintain highly accurate time for extended periods even when the hardware device's connection is severed from reciprocating satellites.

FIG. 2 illustrates high-level architecture of one example of an open time server system diagram, comprising a Time Card hardware extension, host server (e.g., x86 server), and network interface card (NIC) with PPS output.

The Time Card, for example, provides the GNSS signal input and stable frequency input. One advantage to isolating these functions in a Time Card is that it enables a user to select the proper Time Card for system needs (accuracy, stability, cost, etc.)

This hardware extension for all nodes in the blockchain to have the same view of the time of the network down to a microsecond enables them to run consensus in advance to decide which nodes shall be responsible for proposing which blocks precisely at a sub second basis. This predictability of knowing when a node is responsible for what role within the blockchain without having to communicate with other nodes in the network for each decision will result in reduced network overhead and communication costs between nodes to get to the same view of what the next steps of the protocol are required to proceed with progress of the blockchain. The expected result is a highly performant and efficient blockchain, particularly in discovering failed or crashed nodes that require a view change, which is a rotation of the node's responsibility towards another role.

Whereas, clocks on conventional blockchain nodes are not able to be exactly precise and since sending messages across the open Internet is relatively slow compared to the speed of light (e.g., the speed of radio waves communicating with satellites, 300,000 kilometers/186,000 miles per second), blockchain nodes are not able to use precise sub-second parameters to define who is responsible for what next. The messaging to each other across multiple rounds required for consensus in and of itself makes it difficult to remain in agreement of time precision due to clock drift.

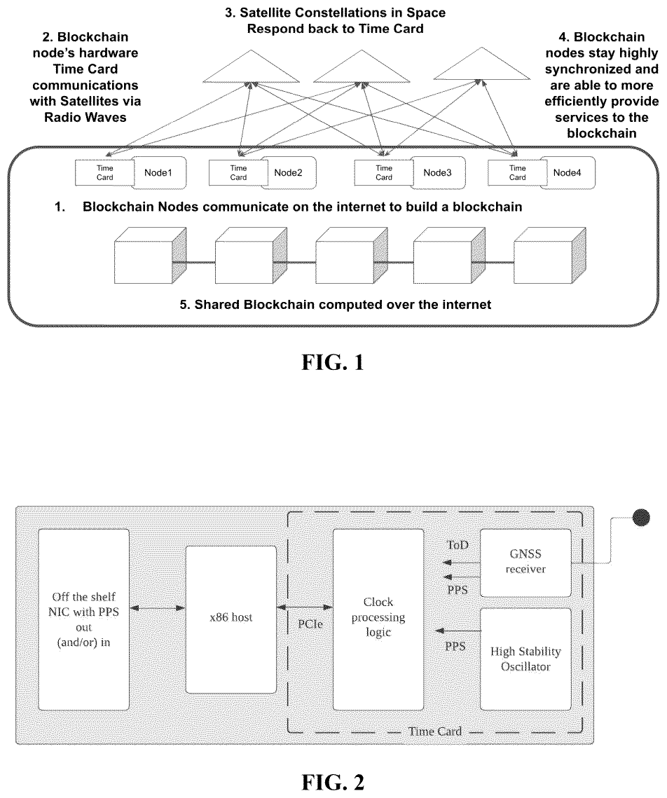

Next, features of the present system design are described, namely explaining how various system components connect and communicate, in context with the exemplary embodiment shown in FIG. 1.

(1) Blockchain node is connected to the Internet and communicates through the Internet to each other to participate utilizing a certain set of deterministic rules that all the nodes in the blockchain must obey, e.g., the blockchain's consensus protocol and execution rules.

The blockchain node comprises a hardware adapter, colloquially known as a “Time Card,” configured to enable the blockchain node to communicate with a plurality of satellites via a Global Navigation Satellite System (GNSS) receiver (2). The “Time Card” comprises a microprocessor, namely a miniature atomic clock (“MAC”), which is designed to measure atomic activity in order to generate a reliable digital sense of time for the computer.

Periodically, (e.g., every 24 hours, every 12 hours, every 4 hours) the blockchain node may need to resynchronize via the GNSS receiver on its Time Card and communicate to satellite constellations in order to ensure it is accurately keeping time. This communication is conducted, for example, through radio frequencies which travel at speed of light and satellites respond back to the Time Card of each node (3). If all nodes are synchronized with the satellite as well as leveraging their natively embedded miniature atomic clock, then all nodes can keep track of time in a highly accurate manner without having to communicate with each other over the Internet and are thereby able to provide efficient computation services to the shared blockchain (4).

While in perfect or near-perfect time synchronization, the blockchain nodes can interact with each other and remain in sync which makes maintaining the blockchain easier and more efficient than had the nodes not been able to stay in perfect or near perfect synchronization across the Internet (5). This eliminates multiple rounds of communication over an otherwise relatively slower Internet to coordinate. Plus, due to communication speeds between nodes on a distributed network, the precision of the time between nodes is relatively large, on the order of 100 s of milliseconds. Whereas, with Time Cards, the nodes can be synchronized to below a millisecond.

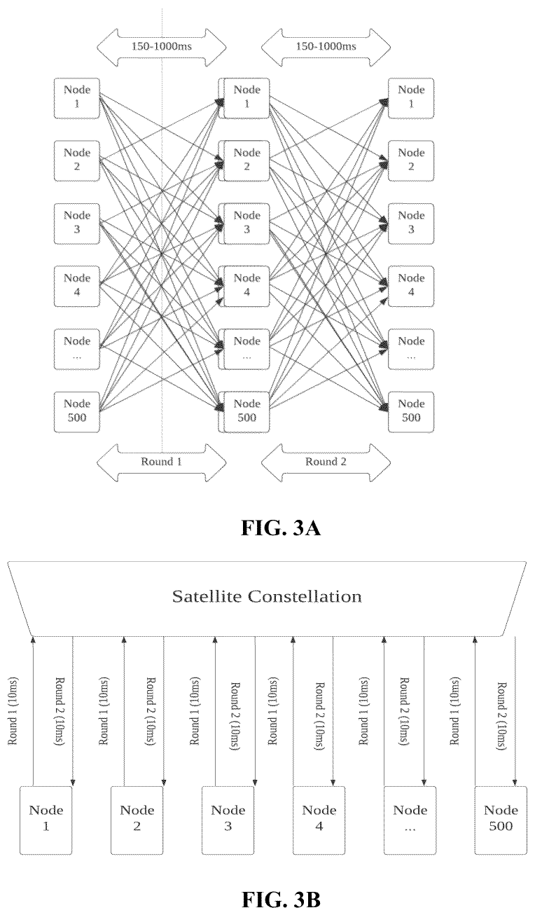

FIGS. 3A and 3B are examples illustrating time synchronization approaches without Time Cards (FIG. 3A) and with Time Cards (FIG. 3B).

FIG. 3A shows a blockchain system without Time Cards, wherein, for example, Nodes must communicate across an unreliable Internet in multiple rounds of communications in order to agree on the next decision, such as the current “Time.” This method lacks precision and takes significantly longer to synchronize. Plus, this must be calibrated every round.

FIG. 3B shows a blockchain system with Time Cards, wherein, for example, nodes communicate with Satellites at the speed of light (radio waves travel this speed) in order to synchronize their clocks to microsecond precision. This method is highly precise and fast to synchronize. Plus, time remains synchronized for long periods with infrequent needs to calibrate clocks.

Moreover, “Time Cards” specifically for blockchains enable tighter time windows (e.g., 200-300 ms) for block proposal, view-change protocols, where a leader node is not responding quickly enough and thus needs to be rotated (for another leader node), thereby, limiting downtime and synchronization over the Internet. Instead, with the Time Cards enabled, blockchain nodes can non-interactively, e.g., without interactively communicating over the relatively slow and asynchronous Internet in multiple hops or rounds, move forward to the next step of the software protocol “automatically,” thereby, for example, saving time to execute and lowering latency to execute computation for the end consumer.

Many blockchain systems do not have a predetermined block schedule. In a blockchain system incorporating predetermined block schedules, every cycle a block proposal schedule may be randomly created with each leader node designated a precise window of time to propose their respective blocks. With “near perfect-time,” these time windows could be rather narrow, on the order of 200-300 ms, which is theoretically enough time for a message to travel around the entire world twice. For contrast, Block Times on Ethereum at the time of writing is around 13 seconds. If there is cryptographic evidence that enough votes have been received within a given time window, for example, 600 ms representing two-time windows, then the consensus protocol could continue to move forward without any interruptions. However, if a cryptographic quorum certificate, which is cryptographic proof that sufficient nodes have voted in agreement, did not arrive within the specified window of time, the next leader in the block proposal rotation schedule could automatically, without getting global agreement on the rotation, propose the next block. Since there can be a deterministic designation of which leader is assigned which time slot, all honest nodes will follow the growth of the blockchain based on the known block proposal schedule. A blockchain's network's throughput is significantly increased with more blocks that are able to be reliably produced.

With Time Cards, the blockchain system can incorporate predetermined block schedules for various tasks and thus can be configured to assign Time Slots to various nodes for block proposals or changes to the network at a precise moment in time and there is reduced risk of missed windows because all of the nodes are operating according to the precise schedule without delay. However, even with Time Cards, a node might experience a hardware malfunction or connectivity issues resulting in missing its time slot. The protocol can move forward to the next allotted known leader with precision and skip the previous leader's opportunity to provide services to the network—without having to communicate through multiple rounds across the Internet to come to agreement on who the next leader is and when they should begin their new role. By utilizing the Time Card, for example, the system can automatically move forward to the next window and the next leader can immediately begin its responsibilities.

The time windows according to the schedule may be a system parameter, which can be adjusted periodically by the participants or automatically via algorithmic adjustments, e.g., based on the performance of the previous cycle, the system can adjust the block slots for the next cycle. For example, if in the previous cycle many block proposal slots were missed, the system could extend the time window longer in the next cycle.

Interestingly, with this Time Card system, there is no need for the system to wait for a full “view change” which is a multi-round all to all node communication procedure that requires multiple quorum certificates to ensure all nodes are on the same page. Instead, the system can bypass this step and automatically move onto the next leader, since the nodes all know exactly at what time the next leader is supposed to be rotated. In essence, if all nodes are using the Time Card, then the system can skip the entire View Change Protocol which is necessary for almost all classical consensus algorithms.

Accordingly, the system can achieve “perfect time” by utilizing the Time Card, which allows the consensus algorithm to behave differently. As noted above, the system can eliminate the “View Change Protocols” which are necessary in other classical consensus algorithms to ensure progress of the chain. By utilizing the Time Card, even if the chain loses synchrony and there are major partitions in the network, once the network corrects and can resume communication with each other, the nodes automatically know with high precision who is next to do what. In other words, utilizing the Time Cards enables the system to be synchronized to a microsecond level or better, and thus the consensus algorithm does not require a traditional view change protocol in case the expected or next leader is not responding.

Without Time Cards, the nodes are not able to function at “perfect time” because even using local clocks, there may be nodes that are operating seconds apart therefore expect a different leader to be proposing for that time slot. Accordingly, the system must include checks (e.g., View Change Protocols) to account for timing discrepancies.

Additionally, to be effectively included in the present distributed system, nodes must incorporate the Time Card. Otherwise the node's vote would not count as part of the super-majority decision and the node would trail behind and lose opportunities to propose blocks and thereby earn block rewards.

Time Cards can be useful for scheduling periodic checkpoints in environments where there are multiple blockchain ledgers being built, such as in sharded blockchain designs (e.g., a core idea in sharded blockchains is that most participants operating or using the network cannot validate blocks in all the shards. As such, whenever any participant needs to interact with a particular shard they generally cannot download and validate the entire history of the shard.) Checkpoints are essentially a snapshot of the state of the ledger and useful to anchor in the total global state. While checkpoints are possible without Time Cards, with them the system can achieve the global checkpoint more efficiently and with less network disruption, since all nodes know exactly and precisely when to do what they must do without communicating with each other over the Internet. So, while nodes usually need to communicate with each other in multiple rounds in order to coordinate to do such types of activities, with the Time Cards the system can non-interactively, e.g., without communicating over the Internet to each other, be on exactly the same page.

With “near perfect-time,” synchronization across these checkpoints becomes substantially easier to coordinate since all honest nodes (e.g., a node that does not try to modify history, which is opposed to an attacker node which tries to modify a past block in the blockchain) can ease into these traditionally communication-complex synchronization periods and at the precise moment in time make the switch to the new network condition, such as what is common during Epoch blocks in which there are major changes to the network responsibilities or node topology.

In addition to providing a clear notion of time within a blockchain consensus protocol (e.g., which functions to provide security to the network), which is also useful for future auditors reviewing historical data, Time Cards have additional blockchain use cases, such as providing a more efficient and precise automation service, which is a smart (or self-executing) contract based decentralized automation or cron-job service (e.g., cron is a time-based job scheduling daemon found in Unix-like operating systems, including Linux distributions and runs in the background and tasks scheduled with cron, referred to as “cron jobs,” are executed automatically, making cron useful for automating maintenance-related tasks) based on consensus rules, to able to execute with extreme precision. For example, triggering an interaction to occur on a blockchain precisely at midnight in a particular time zone.

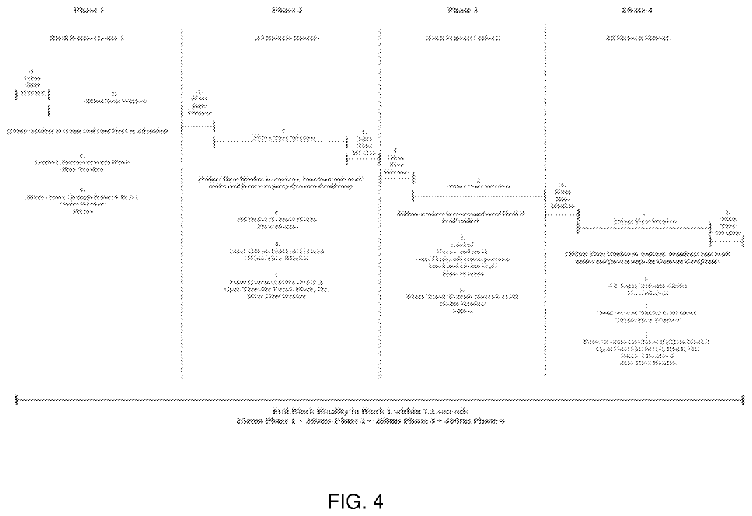

FIG. 4 illustrates one example of Various Phases (Phase 1-4) of a blockchain consensus algorithm utilizing a Time Card in a “happy path,” where two blocks are formed and disseminated and the first block is finalized. Each step in a blockchain consensus protocol has its designated Time Windows in which certain activities, such as block formation and dissemination, must occur within the time window. In the event any of the phases do not complete within the expected time windows, the honest nodes following the protocol will not accept or sign Quorum Certificates. In the next Time Window, the next leader will continue and pick up where the other leader left off.

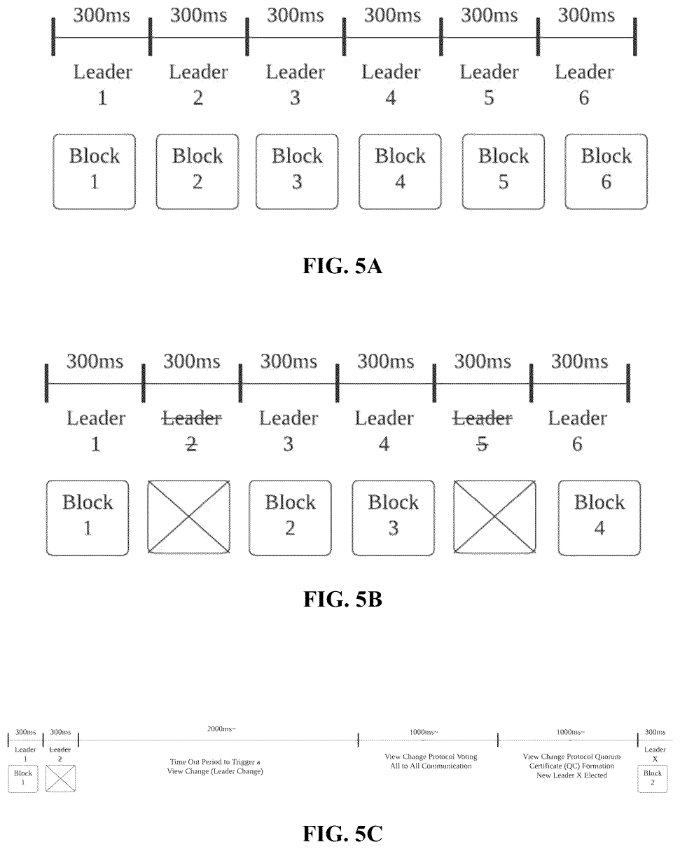

FIG. 5A illustrates one example of block production in a happy path where each designated leader forms and proposes their respective blocks within their allotted time windows, which is configurable, but in this example is set to 300 ms specific time slots.

FIG. 5B illustrates one example of a case when certain leaders are byzantine, slow, crashed, or otherwise unable to produce a block and disseminate it within its designated Time Window. Instead of running a View Change Protocol to rotate the leader via the Internet, nodes instead utilizing their Time Cards will proceed to the next leader to propose the next block.

FIG. 5C illustrates an example of a time delay comparison required to create two blocks in the presence of crashed leader nodes that required a view change protocol voting scheme across the Internet. As shown in FIG. 5B, the next leader is able to pick up immediately upon its respective Time Window approaches, which is possible because every single honest node in the network utilizing the Time Card has near perfect time together to the microsecond level. There is no need to run a time-expensive View Change Protocol over the Internet in multiple rounds of voting in order to elect the next leader and resume the blockchain's progress.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the methods and embodiments described herein. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc, laser disc, optical disc, digital versatile disc, floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present subject matter. Various modifications to these embodiments will be readily apparent to those skilled in the art, and the generic principles defined herein may be applied to other embodiments without departing from the spirit or scope of the subject matter. Thus, the present subject matter is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting.

1. A method, comprising:
enabling a computer to access a distributed ledger system, wherein the distributed ledger system comprising:
a plurality of nodes;
wherein each node of the plurality of nodes comprises a time card and a memory for storing block data;
wherein the time card is a hardware adapter;
wherein the time card comprises a processor, an oscillator, an atomic clock and a Global Navigation Satellite System (GNSS) receiver;
wherein the time card is configured to communicate with a satellite of the GNSS using the GNSS receiver to coordinate time with at least one node of the plurality of nodes;
wherein the plurality of nodes is configured to operate according to a consensus algorithm operating on a block schedule.

2. The method according to claim 1, wherein the block schedule is a predetermined block schedule, and every cycle a block proposal schedule is randomly created, and each leader node of the plurality of nodes is designated a time window to propose respective blocks.

3. The method according to claim 2, wherein the time window is 300 milliseconds or less.

4. The method according to claim 1, wherein the distributed ledger system is programmed such that when the distributed ledger system changes a leader node, the distributed ledger system does not wait for a full view change before changing the leader node.

5. The method according to claim 1, wherein the distributed ledger system is configured to operate without view change protocols.

6. The method according to claim 1, wherein the plurality of nodes is synchronized to within a microsecond.

7. The method according to claim 1, wherein the distributed ledger system is configured to perform a checkpoint without each node of the plurality of nodes communicating with other nodes of the plurality of nodes over the Internet.

8. The method according to claim 1, wherein the block schedule is a predetermined block schedule for one or more tasks, and is configurable to assign time slots to at least one node of the plurality of nodes for block proposals at a certain time, and if an assigned node is not responsive during the time slot, then the distributed ledger system automatically moves forward to the next window and a next leader can immediately begin the one or more tasks.

9. The method according to claim 8, wherein the distributed ledger system is configured such that the plurality of nodes does not communicate directly with one another to come to agreement about which node of the plurality of nodes is the next leader and when the next leader starts.

10. The method according to claim 1, wherein the distributed ledger system is configured to execute a smart contract at a predetermined time.
